(19) United States
(12) Patent Application Publication
(10) Pub. No.: US 2026/0313431 A1
(43) Pub. Date: Oct. 8, 2026

(54) RELAY DEVICE, CONTROL METHOD, AND STORAGE MEDIUM

(71) Applicant: CANON KABUSHIKI KAISHA, Tokyo (JP)

(72) Inventor: MASAKAZU TSUCHIHASHI, Kanagawa (JP)

(21) Appl. No.: 19/636,409

(22) Filed: Apr. 1, 2026

(30) Foreign Application Priority Data
Apr. 4, 2025 (JP) 2025-062172

(51) Int. Cl. H04W 28/02; H04W 88/04

(52) U.S. Cl. CPC H04W 28/02; H04W 88/04

(57) ABSTRACT

A relay device communicates with a first communication device and a second communication device and relays terminal-to-terminal communication, and the relay device includes a reception unit configured to receive a Link Modification Request from the first communication device, and a transmission unit configured to transmit a Link Modification Accept to the first communication device at different timings depending on whether a message type of the Link Modification Request is a first type or a second type.

### BACKGROUND

### Field of the Technology

The present disclosure relates to a relay device, a control method, and a storage medium.

### Description of the Related Art

The 3rd Generation Partnership Project (3GPP®) has formulated a cellular communication standard (also referred to as 3GPP standard). In recent years, Long Term Evolution (LTE) and New Radio (NR) specifications of 3GPP have been under formation. Among these, a standard specification called sidelink communication (hereinafter, simply referred to as sidelink) has been formulated. This specification realizes direct wireless communication between communication terminals using an interface called PC5. A communication terminal is also referred to as a terminal device, terminal, user device, user equipment (UE), or the like.

In regard to Proximity-based Services (ProSe) that is a communication standard for NR sidelink, standardization of 5G ProSe UE-to-UE Relay is currently underway. UE-to-UE Relay is a mechanism in which a relay device (also referred to as a relay) relays communication between wireless terminals in sidelink communication in which two communication terminals (e.g., end UEs) communicate directly without going through a base station. Relaying communication makes it possible to extend the communication distance between communication terminals.

The UE-to-UE Relay standard is described in 3GPP TS 23.304, Proximity-based Services (ProSe) in the 5G System (5GS). By 3GPP Release 18 (Rel-18), link release and link modification for single-hop UE-to-UE Relay using one relay device had been standardized. Toward Release 19 (Rel-19), discussions are currently underway on single-hop functional extensions using one relay device and UE-to-UE Relay using a plurality of relay devices (also called multi-hop UE-to-UE Relay).

In the multi-hop UE-to-UE Relay, a plurality of relay devices is connected between the end UEs, so it is considered that the time from transmission of a link modification request message to reception of a link modification response message will be long. In the case of performing link release using a link modification request message, the link release process is performed after reception of the link modification response message. Accordingly, in the case of performing link release using a link modification request message in multi-hop UE-to-UE Relay, the time until link release will be long. As such, there is room for consideration of relay communication using relay devices.

### SUMMARY

The UE-to-UE Relay link modification process is realized by processes A and B. The process A is a process of relaying a link modification request (Link Modification Request) message from the source end UE to the target end UE. The process B is a process of relaying a link modification accept (Link Modification Accept) message from the target end UE to the source end UE.

In view of the above, an aspect of the present disclosure is directed to providing a technology for appropriately performing relay communication using a relay device.

According to an aspect of the present disclosure, a relay device communicates with a first communication device and a second communication device and relays terminal-to-terminal communication, and the relay device includes a reception unit configured to receive a Link Modification Request from the first communication device, and a transmission unit configured to transmit a Link Modification Accept to the first communication device at different timings depending on whether a message type of the Link Modification Request is a first type or a second type.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration example of a relay device according to an embodiment.

FIG. 2 is a block diagram illustrating a functional configuration example of the relay device according to the embodiment.

FIG. 3 is a diagram illustrating a configuration example of a communication system according to the embodiment.

FIG. 4 is a sequence diagram illustrating an example of a link modification process for multi-hop UE-to-UE Relay according to a first embodiment.

FIG. 5 is a diagram illustrating an example of processing performed by a relay device according to the first embodiment.

FIG. 6 is a diagram illustrating an example of processing performed by a relay device according to a second embodiment.

FIG. 7 is a diagram illustrating an example of processing performed by a relay device according to a third embodiment.

### DESCRIPTION OF THE EMBODIMENTS

Hereinafter, embodiments will be described in detail with reference to the accompanying drawings. Note that the following embodiments do not limit the scope of the claims. Although the embodiments include a plurality of features, not all of the plurality of features are necessarily essential to the present disclosure, and the plurality of features may be combined arbitrarily. In the accompanying drawings, the same reference numerals may be used to designate identical or similar components, and redundant description thereof may be omitted. Furthermore, the technical scope of the present disclosure is determined by the claims, and is not limited by the individual embodiments below.

In this specification and drawings, "release" may be replaced with "disconnection". Also, in this specification and drawings, "link modification request" and "link modification request message" are used interchangeably. The same applies to other messages.

### First Embodiment

In the present embodiment, a message transmission process of a relay device in a link modification sequence of multi-hop UE-to-UE Relay will be described.

### Configuration of Relay Device

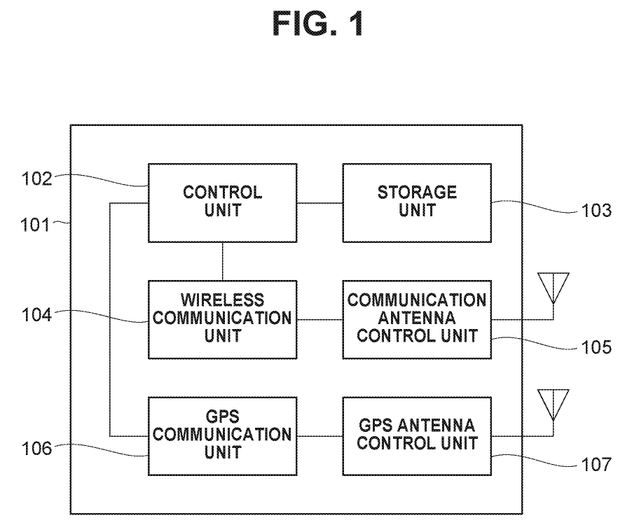

FIG. 1 is a block diagram illustrating a hardware configuration example of a relay device according to the present embodiment. The relay device according to the present embodiment is a relay device (e.g., a relay terminal) that relays sidelink communication between terminals to extend the coverage of the sidelink communication.

As illustrated in FIG. 1, a hardware configuration 101 of the relay device includes a control unit 102, a storage unit 103, a wireless communication unit 104, a communication antenna control unit 105, a global positioning system (GPS) communication unit 106, and a GPS antenna control unit 107, for example.

The control unit 102 consists of one or more processors, such as a central processing unit (CPU) or a micro processing unit (MPU). The control unit 102 controls the entire relay device by executing a control program stored in the storage unit 103 (a control program read into a random access memory (RAM)), for example. Note that the processes performed by the control unit 102, which will be described below with reference to flowcharts, can also be implemented using hardware circuits such as ASICs and FPGAs. ASIC is an abbreviation for application specific integrated circuit, and FPGA is an abbreviation for field programmable gate array. Furthermore, the processes described below with reference to flowcharts can also be implemented by cooperation between hardware circuits and processors such as a CPU or MPU.

The storage unit 103 stores control programs to be executed by the control unit 102 and various types of information such as cell information and connected terminal information. The storage unit 103 may include a main storage unit and an auxiliary storage unit. The main storage unit is a read-only memory (ROM), a RAM, or the like, for example. The main storage unit may store or temporarily store programs and data such as an operating system (OS), which is basic software to be executed by the control unit 102, and application software. The auxiliary storage unit is a hard disk drive (HDD), a solid state drive (SSD), or the like, for example, and may store data related to application software and the like. For example, control programs stored in a non-volatile memory area are developed into RAM and executed by a processor constituting the control unit 102.

In this way, the control unit 102 and the storage unit 103 may function as a computer.

The wireless communication unit 104 performs cellular communication such as Long Term Evolution (LTE) and 5G (NR) conforming to the 3GPP standard. Note that, although various embodiments including the present embodiment will be described with regard to 5G, the present disclosure can also be applied to systems other than 5G (for example, next-generation mobile communication systems such as 5G Advanced and 6G, LTE, LTE-Advanced, combinations thereof, and the like).

The communication antenna control unit 105 controls an antenna for wireless communication performed by the wireless communication unit 104. For example, the communication antenna control unit 105 controls the antenna so as to switch the directivity direction of the antenna.

The GPS communication unit 106 receives satellite signals from Global Positioning System (GPS) satellites to acquire current position information including position identification information such as longitude and latitude information, current time information, and the like. The GPS communication unit 106 may have a function to measure (e.g., locate) the current position based on the satellite signals. Note that another Global Navigation Satellite System (GNSS) may be used instead of or in addition to GPS.

The GPS antenna control unit 107 controls the antenna for GPS communication performed by the GPS communication unit 106.

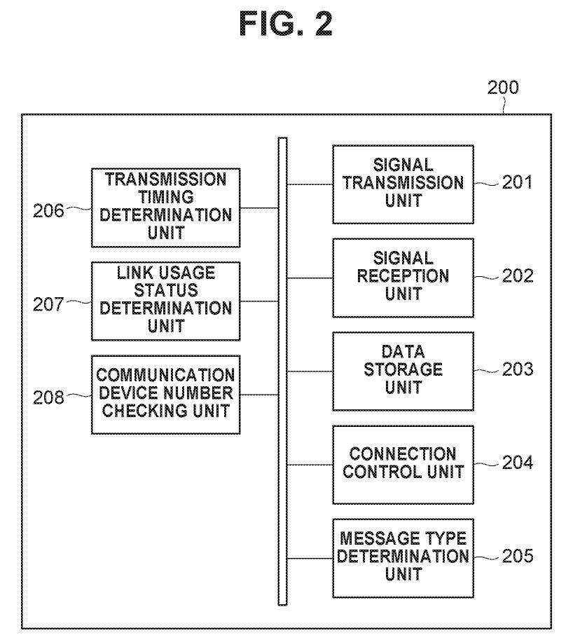

FIG. 2 is a block diagram illustrating a functional configuration example of a relay device according to the present embodiment. The functional blocks illustrated in FIG. 2 may be implemented by software.

The software function 200 illustrated in FIG. 2 includes a signal transmission unit 201, a signal reception unit 202, a data storage unit 203, a connection control unit 204, a message type determination unit 205, a transmission timing determination unit 206, a link usage status determination unit 207, and a communication device number checking unit 208.

The signal transmission unit 201 (an example of a transmission unit or transmission means) and the signal reception unit 202 (an example of a reception unit or reception means) perform cellular communication such as LTE or 5G (NR) conforming to the 3GPP standard with a communication device. Note that a link modification request message, a link modification response message, a disconnect request message, and a disconnection response message, which will be described below, are transmitted and received by the signal transmission unit 201 and the signal reception unit 202. The signal transmission unit 201 and the signal reception unit 202 may also be referred to as a signal transmission/reception unit or transmission/reception means, a signal communication unit or communication means, or the like.

The data storage unit 203 stores and holds information about the software (e.g., program) and the currently connected terminal.

The connection control unit 204 controls sidelink connections, relay connections, and the like with other communication devices.

The message type determination unit 205 (an example of a determination unit or determination means) determines the message type of a link modification request message received from a communication device forming a UE-to-UE Relay.

The transmission timing determination unit 206 (an example of a determination unit or determination means) determines the timing for transmitting a link modification response message to the communication device that has transmitted the link modification request message. For example, the transmission timing determination unit 206 determines the timing for transmitting a link modification request message to the next communication device (e.g., another relay device or end UE) based on the determined message type. More specifically, the transmission timing determination unit 206 determines whether to transmit a message first to the next communication device or transmit a message first to the communication device that has transmitted the link modification request message, based on the determined message type. The message to be transmitted to the next communication device is a link modification request message or a disconnect request message, and the message to be transmitted to the communication device that has transmitted the link modification request message is a link modification response message. Details of the method for determining the transmission timing will be described below.

The link usage status determination unit 207 (an example of a determination unit or determination means) determines the usage status of a link (in other words, a communication path) to a communication device that forms a UE-to-UE Relay.

The method for determining the link usage status will be described in a second embodiment.

When the relay device receives a link modification request message, the communication device number checking unit 208 (an example of a determination unit or determination means) checks (e.g., determines) the number of relay devices forming a UE-to-UE Relay (that is, the number of relay devices relaying terminal-to-terminal communication). The checking method will be described in a third embodiment.

Note that some (or all in some cases) of the described functional blocks may be replaced with other functional blocks that perform similar functions, some of the functional blocks may be omitted, or further functional blocks may be added. One functional block may be divided into a plurality of functional blocks, or a plurality of functional blocks may be integrated into one functional block. Furthermore, only some of the functional blocks may be configured in hardware, and the remaining functions configured in software. When the functional blocks are configured in software, the processor constituting the control unit 102 illustrated in FIG. 1 executes control programs for implementing the functions stored in the storage unit 103 illustrated in FIG. 1. This provides the functions of the functional blocks.

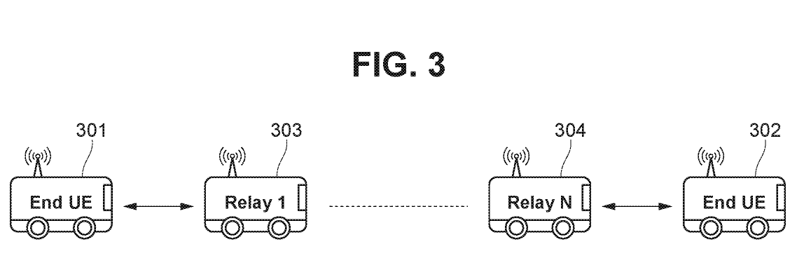

FIG. 3 is a diagram illustrating a configuration example of a communication system according to the present embodiment. In the example illustrated in FIG. 3, two end UEs and N relay devices form a UE-to-UE Relay.

An end UE 301 is connected to a first relay device 303, and an end UE 302 is connected to an Nth relay device 304. One or more (N-2) relay devices are connected in series between the first relay device 303 and the Nth relay device 304 (when N is 3 or more). Alternatively, there is no relay device between the first relay device 303 and the Nth relay device 304, and the first relay device 303 and the Nth relay device 304 (when N is 2) are connected together. This UE-to-UE Relay is connected by one or more Quality of Service (QoS) flows. A QoS flow is a virtual transmission path generated for each QoS. Each QoS flow is identified by identification information or an identifier called a QoS Flow Identifier (QFI). In the link modification process, it is possible to control a QoS included in a link, such as adding a QoS flow to an existing link, changing the setting of a QoS flow included in an existing link, or deleting a QoS flow from an existing link.

In the present embodiment, the number of relay devices is two (N = 2), and the UE-to-UE Relay is connected by one QoS flow.

Next, a link modification request (e.g., Link Modification Request) message will be described. In this specification and the drawings, the link modification request message is an example of a message that requests modification of a communication path.

The Link Modification Request message format used in the present embodiment is the message format defined in TS 24.554. Specifically, the Link Modification Request includes a Link modification operation code information element, a PC5 QoS flow descriptions information element, and the like.

The Link Modification Request is used to add a QoS flow to an existing link, change the settings of a QoS flow included in an existing link, or delete a QoS flow from an existing link. These operations, such as addition, modification, and deletion, are separately performed by specifying a message type. The message type is specified in the Link modification operation code field of the Link modification operation code information element. For example, in the case of deleting a QoS flow, the end UE specifies a value indicating the deletion of the QoS flow (5 (decimal): 0101 (binary)) as the message type. Then, the end UE stores the QFI of the QoS flow to be deleted in the PQFI field of the PC5 QoS flow description in the PC5 QoS flow descriptions information element. PQFI is an abbreviation for PC5 QoS Flow Identifier. A relay device that has received the Link Modification Request message can know, from the message type and PQFI included in the message, the request for QoS flow deletion and the QFI to be deleted.

Next, a method for determining the timing for transmitting a link modification response (e.g., Link Modification Accept) message by the relay device will be described. In the present embodiment, the relay device determines the transmission timing based on the message type of the received link modification request message. The link modification response message may also be called a link modification accept message, and is an example of a message that accepts a modification of a communication path, a response message to a message that requests a modification of a communication path, or the like.

The relay device (e.g., message type determination unit 205) that has received the link modification request message checks the link modification operation code field of the received message to acquire and determine the message type.

If the message type indicates QoS flow deletion, the relay device (e.g., transmission timing determination unit 206) operates as follows. That is, the relay device determines that a link modification response message is to be transmitted to the communication device having transmitted the link modification request message, before transmitting a link modification request message to the next communication device (e.g., relay device or end UE). Then, the relay device transmits the link modification response message to the communication device that has transmitted the link modification request message, before transmitting the link modification request message to the next communication device. The purpose of transmitting the link modification response message before transmitting the link modification request message is to advance the link disconnection (e.g., release) timing.

Another method for releasing a link is to use a disconnect request (e.g., Disconnect Request) message. When receiving this disconnect request message, the relay device may transmit a disconnect response (e.g., Disconnect Response) message to the communication device that has transmitted the disconnect request message, before transmitting a message to the next communication device. This makes it possible to, when two different messages for link release are received, synchronize the timings for transmitting response messages. The disconnect request message is an example of a message that requests disconnection of a communication path. The disconnect response message may also be called a disconnection accept message, and is an example of a message that accepts disconnection of a communication path, a response message to a message that requests disconnection of a communication path, or the like.

On the other hand, if the message type indicates anything other than QoS flow deletion, the relay device (e.g., transmission timing determination unit 206) operates as follows, as before. That is, the relay device determines that a link modification request message is to be transmitted to the next communication device (e.g., relay device or end UE), before transmitting a link modification response message to the communication device that has transmitted the link modification request message. More specifically, the relay device determines that a link modification response message is to be transmitted to the communication device that has transmitted the link modification request message, after transmitting the link modification request message to the next communication device and receiving the link modification response message from the next communication device. Then, the relay device transmits the link modification request message to the next communication device and receives the link modification response message from the next communication device, and then transmits the link modification response message to the communication device that has transmitted the link modification request message.

### Operations of Communication Device

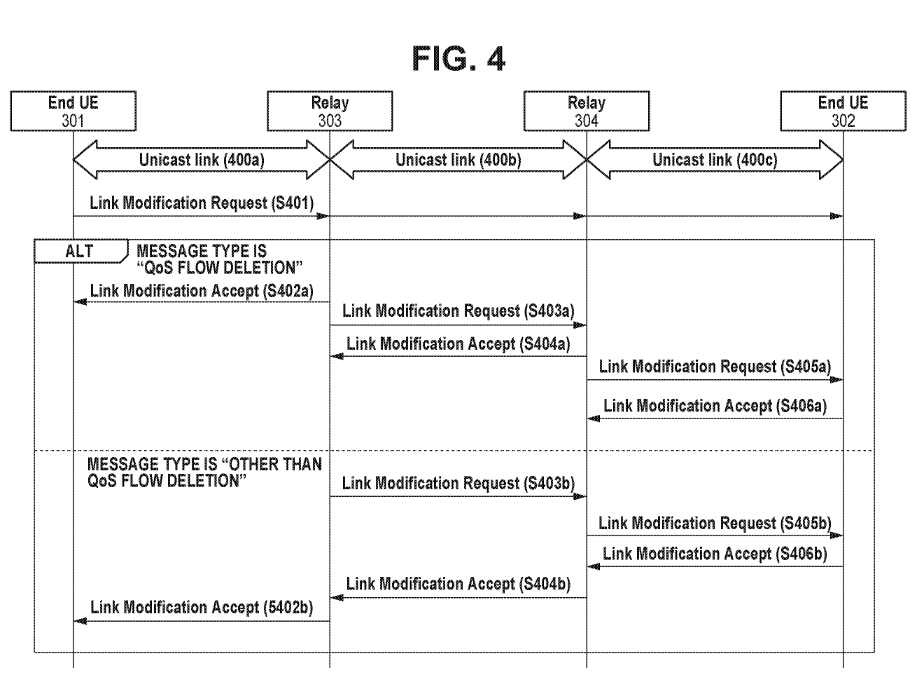

FIG. 4 is a sequence diagram illustrating an example of a link modification process for multi-hop UE-to-UE Relay according to the present embodiment.

The end UE 301 and the relay device 303 form a unicast link (400a). The relay device 303 and the relay device 304 form a unicast link (400b). The relay device 304 and the end UE 302 form a unicast link (400c).

In step S401, the end UE 301 transmits a link modification request message (e.g., Link Modification Request) to the relay device 303. Upon receipt of the Link Modification Request from the end UE 301, the relay device 303 acquires and determines the message type of the Link Modification Request. If the message type indicates QoS flow deletion, in step S402a, the relay device 303 operates as follows. That is, the relay device 303 responds with a link modification response message (e.g., Link Modification Accept), releases (e.g., deletes) the QoS flow to be deleted, and deletes all context data associated with the QoS flow.

Next, in step S403a, the relay device 303 transmits a Link Modification Request of the message type indicating QoS flow deletion, to the relay device 304.

Upon receipt of the Link Modification Request from the relay device 303, the relay device 304 acquires and determines the message type. If the message type indicates QoS flow deletion (in this example, the message type indicates QoS flow deletion), the relay device 304 operates as follows. That is, in step S404a, the relay device 304 responds with a Link Modification Accept, releases (e.g., deletes) the QoS flow to be deleted, and deletes all context data associated with the QoS flow.

Next, in step S405a, the relay device 304 transmits a Link Modification Request of the message type indicating QoS flow deletion, to the end UE 302.

Upon receipt of the Link Modification Request from the relay device 304, the end UE 302 acquires and determines the message type. If the message type indicates QoS flow deletion (in this example, the message type indicates QoS flow deletion), the end UE 302 operates as follows. That is, in step S406a, the end UE 302 responds with a Link Modification Accept, releases (e.g., deletes) the QoS flow to be deleted, and deletes all context data associated with the QoS flow.

If the message type of the Link Modification Request transmitted by the end UE 301 and received by the relay device 303 in step S401 indicates a type other than QoS flow deletion, the relay device 303 operates as follows. That is, in step S403b, the relay device 303 transmits a Link Modification Request of the same message type to the relay device 304.

Upon receipt of the Link Modification Request from the relay device 303, the relay device 304 acquires and determines the message type. If the message type indicates a type other than QoS flow deletion (in this example, the message type indicates a type other than QoS flow deletion), the relay device 304 operates as follows. That is, in step S405b, the relay device 304 transmits a Link Modification Request of the same type to the end UE 302.

Upon receipt of the Link Modification Request from the relay device 304, in step S405b, the end UE 302 responds with a Link Modification Accept and performs processing according to the message type.

Upon receipt of the Link Modification Accept from the end UE 302, in stepS406b, the relay device 304 transmits a Link Modification Accept to the relay device 303 and performs processing according to the message type.

Upon receipt of the Link Modification Accept from the relay device 304, in step S404b, the relay device 303 transmits a Link Modification Accept to the end UE 301 and performs processing according to the message type.

Finally, upon receipt of the Link Modification Accept from the relay device 303, the end UE 301 performs processing according to the message type.

Next, an example of a process flow will be described in which, when receiving a Link Modification Request, the relay device controls the timing for transmitting a Link Modification Accept based on the message type.

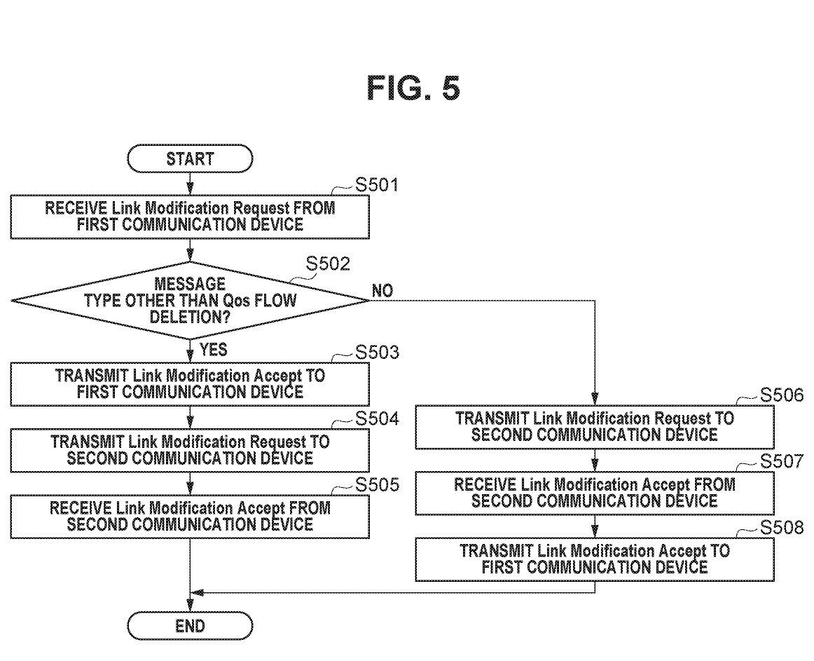

FIG. 5 is a diagram illustrating an example of processing by the relay device according to the present embodiment. Specifically, FIG. 5 illustrates an example of processing in which the relay device receives a Link Modification Request from a first communication device and changes the transmission timing (and the message to be transmitted) based on the message type. In the present embodiment, it is assumed that the first communication device is an end UE and a second communication device is a relay device, or that the first communication device is a relay device and the second communication device is either a relay device or an end UE.

First, in step S501, the relay device receives a Link Modification Request from the first communication device, and in step S502, the relay device determines the message type of the Link Modification Request.

If the message type indicates QoS flow deletion (YES in step S502), in step S503, the relay device transmits a Link Modification Accept to the first communication device. Next, in step S504, the relay device transmits a Link Modification Request to the second communication device, in step S505, the relay device receives a Link Modification Accept from the second communication device, and the process is ended.

Note that the message transmitted by the relay device to the second communication device in step S504 may be a Disconnect Request instead of a Link Modification Request. In this case, the message received from the second communication device in step S505 (e.g., a response message to the message transmitted in step S504) may be a Disconnect Response. For example, if only the QoS flow requested to be deleted in the link modification request message received by the relay device exists on the link, it can be determined that the link will be released after deletion of the QoS flow (e.g., refer to the second embodiment). Accordingly, in this case, in step S504, the relay device may transmit a Disconnect Request to the second communication device instead of a Link Modification Request.

In step S502, if the message type does not indicate QoS flow deletion (NO in step S502), in step S506, the relay device transmits a Link Modification Request to the second communication device. After that, in step S507, upon receipt of the Link Modification Accept from the second communication device, in step S508, the relay device transmits a Link Modification Accept to the first communication device, and the process is ended.

As above, in the present embodiment, the processing performed by the relay device forming a UE-to-UE Relay upon receipt of a Link Modification Request has been described. In the present embodiment, the relay device changes the transmission timing (and the message to be transmitted) based on the message type of the received message. Specifically, if the message type indicates QoS flow deletion, the relay device transmits a Link Modification Accept to the transmitter of the received message, before transmitting a Link Modification Request to the next communication device. In this way, in the link release process using link modification messages, changing the timing for transmitting a link modification response message based on the message type of a link modification request message received by the relay device makes it possible to advance the timing of link release. Accordingly, relay communication using the relay device can be performed appropriately.

### Second Embodiment

In the first embodiment, an example has been described in which the timing for transmitting a link modification response message when the relay device forming a UE-to-UE Relay receives a link modification request message is changed based on the message type of the received message.

More specifically, in the first embodiment, when the message type indicates QoS flow deletion, the timing for transmitting a Link Modification Accept is advanced. However, even when the message type indicates QoS flow deletion, there are cases where the timing for transmitting a Link Modification Accept does not need to be advanced. For example, when the link includes a QoS flow other than the QoS flow to be deleted, only the QoS flow to be deleted will be deleted, and the link will not be released. In this case, since the connection with the communication device is maintained, the timing for transmitting a Link Modification Accept does not necessarily need to be advanced.

Accordingly, in the present embodiment, an example will be described in which the timing for transmitting a link modification response message when a relay device forming a UE-to-UE Relay receives a link modification request message is changed based on the message type and the link usage status.

In the following, description of the configuration and processing that are the same as or similar to those in the first embodiment will be omitted, and the configuration and processing that are different from those in the first embodiment will be mainly described.

First, a method for the relay device to determine the link usage status and determine the timing for transmitting a Link Modification Accept will be described.

The link usage status is determined (e.g., or judged) by a link usage status determination unit 207 based on the QoS flow included in the link and the QFI to be deleted, which is specified in the link modification request message.

In a case where only the QoS flow requested to be deleted in the link modification request message exists on the link, it can be determined that the link will be released after deletion of the QoS flow. In this case, the relay device (e.g., transmission timing determination unit 206) determines that a Link Modification Accept is to be transmitted, before a Link Modification Request is transmitted, in order to advance the link release.

On the other hand, in a case where the QoS flow requested to be deleted in the link modification request message and other QoS flows exist on the link, it can be determined that the link will not be released even after deletion of the QoS flow. In this case, since it is not necessary to advance the timing of link release, the relay device (e.g., transmission timing determination unit 206) determines that a Link Modification Accept is to be transmitted after communication with the relay destination communication device.

In summary, the transmission timing determination unit 206 determines the timing for transmitting a link modification request message to the next communication device based on the message type of the received link modification request message and the link usage status. More specifically, the transmission timing determination unit 206 determines whether to transmit first a message to the next communication device or transmit first a message to the communication device that has transmitted the link modification request message, based on the message type and the link usage status.

Next, an example of a process flow will be described in which the relay device controls the timing for transmitting a Link Modification Accept based on the message type and the link usage status when the relay device receives a Link Modification Request.

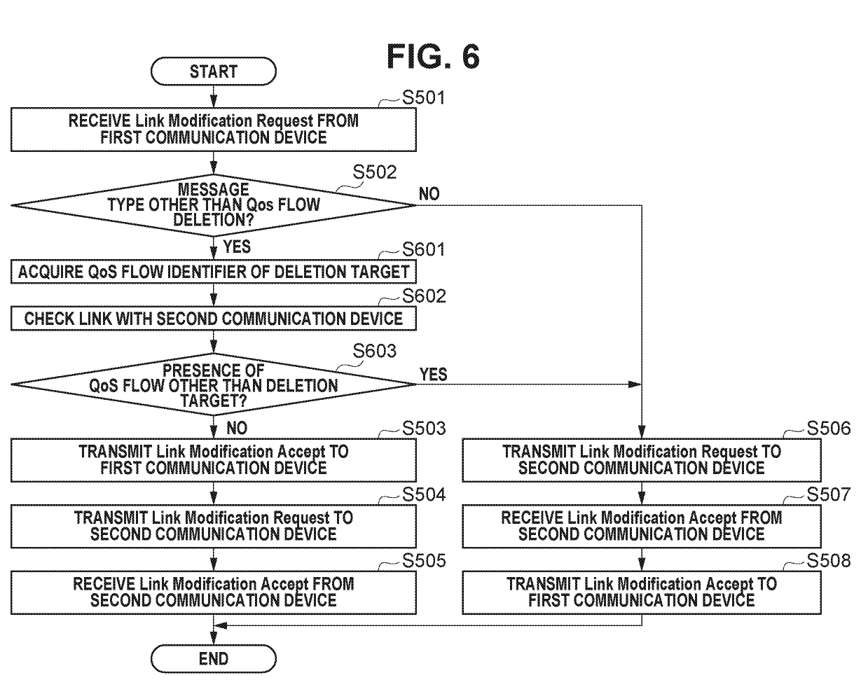

FIG. 6 is a diagram illustrating an example of processing by the relay device according to the present embodiment. Specifically, FIG. 6 illustrates an example of processing in which the relay device receives a Link Modification Request from the first communication device and changes the transmission timing (e.g., and the message to be transmitted) based on the message type and the link usage status. In the present embodiment, it is assumed that the first communication device is an end UE and the second communication device is a relay device, or that the first communication device is a relay device and the second communication device is either a relay device or an end UE.

First, in step S501, the relay device receives a Link Modification Request from the first communication device, and in step S502, the relay device determines the message type of the Link Modification Request.

If the message type indicates QoS flow deletion (YES in step S502), in step S601, the relay device 304 acquires the identifier of the QoS flow to be deleted. Then, in step S602, the relay device 304 checks the link formed with the second communication device (more specifically, the QoS flow included in the link).

Next, the relay device determines the usage status of the link based on the QoS flows included in the link. Specifically, in step S603, the relay device determines whether the link includes any QoS flow other than the QoS flow to be deleted.

If the link does not include any QoS flow other than the QoS to be deleted (NO in step S603), the relay device operates as follows. That is, the relay device determines that the link will be released after deletion of the QoS flow, and determines that a Link Modification Accept is to be transmitted first to the first communication device in order to advance the timing of link release, and the process proceeds to step S503. Step S503 and subsequent steps are the same as those in the first embodiment, and thus description thereof will be omitted.

On the other hand, if the link includes any QoS flow other than the QoS flow to be deleted (YES in step S603), the relay device operates as follows. That is, the relay device determines that the link will not be released after deletion of the QoS flow, and determines that communication is to be made with the second communication device first and then a Link Modification Accept is to be transmitted to the first communication device. Then, the process proceeds to step S506. Step S506 and the subsequent steps are the same as those in the first embodiment, and thus description thereof will be omitted.

In step S502, if the message type does not indicate QoS flow deletion (NO in step S502), the relay device proceeds to step S506. Step S506 and the subsequent steps are the same as those in the first embodiment, and thus description thereof will be omitted.

As above, in the present embodiment, the process performed by the relay device forming a UE-to-UE Relay upon receipt of a Link Modification Request has been described. In the present embodiment, the relay device changes the transmission timing (e.g., and the message to be transmitted) based on the message type of the received message and the link usage status. Specifically, if the message type indicates QoS flow deletion and no QoS flows other than the QoS flow to be deleted are included in the link, the relay device operates as follows. That is, the relay device transmits a Link Modification Accept to the transmitter of the received message before transmitting a Link Modification Request to the next communication device. On the other hand, if the message type indicates QoS flow deletion and a QoS flow other than the QoS flow to be deleted is included in the link, the relay device operates as follows. That is, the relay device transmits a Link Modification Accept to the transmitter of the received message after communicating with the next communication device. In this way, in the link release process, it is possible to advance the timing of link release by changing the transmission timing of the link modification response message based on the message type of the link modification request message received by the relay device and the link usage status. On the other hand, if it is not necessary to advance the timing of link release, it is sufficient to transmit and receive messages according to the conventional procedure. Accordingly, relay communication using the relay device can be performed appropriately.

### Third Embodiment

In the first and second embodiments, examples have been described in which the timing for transmitting a Link Modification Accept is controlled based on the message type and, in some cases, the link usage status.

However, if the number of relay devices in the multi-hop UE-to-UE Relay (that is, the number of hops in terminal-to-terminal communication) is not large, it is expected that the time until the link release will not be so long. In this case, it can be said that there is no need to advance the timing of the link release. Accordingly, the relay device may obtain the number of relay devices forming a UE-to-UE Relay, and perform the above control only when the number of relay devices is equal to or greater than a threshold.

The number of relay devices forming a UE-to-UE Relay can be obtained from the List of candidates U2U relay UE info field included in a Link Modification Request. Specifically, the List of candidates U2U relay UE info field includes a list of User Info IDs of the relay devices. The relay device (e.g., communication device number checking unit 208) can obtain and grasp the number of relay devices from the number of User Info IDs included in the list.

In the present embodiment, an example will be described in which the transmission timing of a link modification response message when a relay device forming a UE-to-UE Relay receives a link modification request message is changed based on the message type and the number of relay devices.

In the following, description of configurations and processes that are the same as or similar to those of the first or second embodiment will be omitted, and the description will focus on configurations and processes that are different from those of the first or second embodiment.

In the present embodiment, the transmission timing determination unit 206 determines the timing for transmitting a link modification request message to the next communication device based on the message type of the received link modification request message and the number of relay devices that form a UE-to-UE Relay. More specifically, the transmission timing determination unit 206 determines whether to transmit a message first to the next communication device or to transmit a message first to the communication device that has transmitted the link modification request message, based on the message type and the number of relay devices.

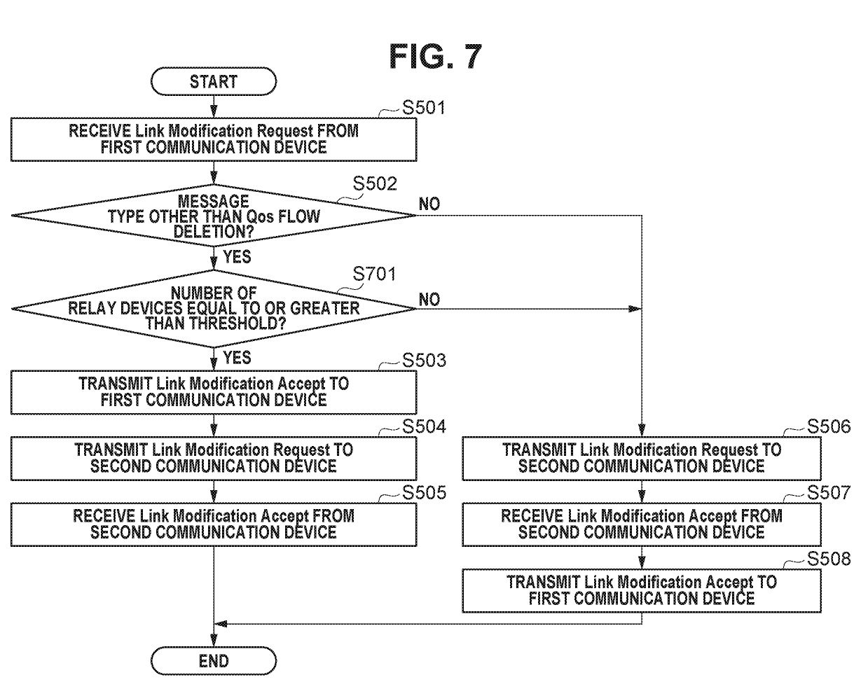

FIG. 7 is a diagram illustrating an example of processing by the relay device according to the present embodiment. Specifically, FIG. 7 illustrates an example of processing in which the relay device receives a Link Modification Request from a first communication device and changes the transmission timing (e.g., and the message to be transmitted) based on the message type and the number of relay devices. In the present embodiment, it is assumed that the first communication device is an end UE and a second communication device is a relay device, or that the first communication device is a relay device and the second communication device is either a relay device or an end UE.

First, in step S501, the relay device receives a Link Modification Request from the first communication device, and in step S502, the relay device determines the message type of the Link Modification Request.

In a case where the message type indicates QoS flow deletion (YES in step S502), in step S701, the relay device acquires the number of relay devices that form the UE-to-UE Relay and determines whether the number of relay devices is equal to or greater than a threshold.

In a case where the number of relay devices is equal to or greater than the threshold (YES in step S701), the relay device determines that a process for advancing the timing of link release is to be executed, and the process proceeds to step S503. Step S503 and subsequent steps are the same as those in the first embodiment, and thus description thereof will be omitted.

On the other hand, in a case where the number of relay devices is less than the threshold (NO in step S701), the relay device determines that the process for advancing the timing of link release is not to be executed, and the process proceeds to step S506. Step S506 and subsequent steps are the same as those in the first embodiment, and thus description thereof will be omitted.

In step S502, if the message type does not indicate QoS flow deletion (NO in step S502), the process proceeds to step S506. Steps S506 and subsequent steps are the same as those in the first embodiment, and thus description thereof will be omitted.

As above, in the present embodiment, the processing performed by the relay device forming a UE-to-UE Relay upon receipt of a Link Modification Request has been described. In the present embodiment, the relay device changes the transmission timing (e.g., and the message to be transmitted) based on the message type of the received message and the number of relay devices. Specifically, if the message type indicates QoS flow deletion and the number of relay devices is equal to or greater than a threshold, the relay device operates as follows. That is, the relay device transmits a Link Modification Accept to the transmitter of the received message, before transmitting a Link Modification Request to the next communication device. On the other hand, if the message type indicates QoS flow deletion and the number of relay devices is less than the threshold, the relay device operates as follows. That is, the relay device transmits a Link Modification Accept to the transmitter of the received message, after communication with the next communication device. In this way, in the link release process, the transmission timing of the link modification response message is changed based on the message type of the link modification request message received by the relay device and the number of relay devices, thereby making it possible to advance the timing of link release. On the other hand, if it is not necessary to advance the timing of link release, messages can be transmitted and received according to the conventional procedure. Accordingly, relay communication using the relay device can be performed appropriately.

### Other Embodiments

Although the multi-hop UE-to-UE Relay has been described above, the present disclosure may also be applied to a single-hop UE-to-UE Relay. That is, the first communication device and the second communication device described with reference to FIGS. 5 to 7 may be both end UEs.

The present disclosure can also be implemented by a process in which a program that implements one or more functions of the above-described embodiments is supplied to a system or device via a network or storage medium, and one or more processors in the computer of the system or device read and execute the program. The present disclosure can also be implemented by a circuit (for example, an ASIC or an FPGA) that implements one or more functions.

The present disclosure is not limited to the above-described embodiments, and various changes and modifications can be made without departing from the spirit and scope of the present disclosure.

The names of the functional units, messages, parameters, fields, and the like described in the above embodiments are merely examples and may be changed to other names.

The matters described in the above embodiments may be incorporated into other embodiments as long as they are not inconsistent. For example, a Link Modification Accept may be transmitted first to the first communication device if the message type indicates QoS flow deletion, no QoS flows other than the QoS flow to be deleted are included in the link, and the number of relay devices is equal to or greater than a threshold.

In addition, the following supplementary notes are disclosed regarding the above-described embodiments.

### Supplementary Note 1

A relay device that communicates with a first communication device and a second communication device and relays terminal-to-terminal communication, the relay device including:

a reception unit configured to receive a Link Modification Request from the first communication device; and

a transmission unit configured to transmit a Link Modification Accept to the first communication device at different timings depending on whether a message type of the Link Modification Request is a first type or a second type.

### Supplementary Note 2

The relay device according to Supplementary Note 1,

wherein the first type is a Link Modification Request indicating QoS flow deletion, and

wherein in a case where the message type is the first type, the transmission unit transmits the Link Modification Accept to the first communication device before transmitting a predetermined message to the second communication device.

### Supplementary Note 3

The relay device according to Supplementary Note 1,

wherein the second type is a Link Modification Request that does not indicate QoS flow deletion, and

wherein in a case where the message type is the second type, the transmission unit transmits a predetermined message to the second communication device, and transmits the Link Modification Accept to the first communication device after receiving a response message to the predetermined message from the second communication device.

### Supplementary Note 4

The relay device according to Supplementary Note 1, further including a first determination unit configured to determine a usage status of a communication path between the relay device and the second communication device based on the Link Modification Request, and

wherein the transmission unit transmits the Link Modification Accept to the first communication device based on the message type and the usage status.

### Supplementary Note 5

The relay device according to Supplementary Note 4, wherein the first determination unit determines the usage status based on a first QoS flow included in the communication path.

### Supplementary Note 6

The relay device according to Supplementary Note 5, wherein in a case where the message type is the first type and the communication path includes only the first QoS flow, the transmission unit transmits the Link Modification Accept to the first communication device before transmitting a predetermined message to the second communication device.

### Supplementary Note 7

The relay device according to Supplementary Note 5, wherein in a case where the message type is the second type and the communication path includes the first QoS flow and a second QoS flow other than the first QoS flow, the transmission unit transmits a predetermined message to the second communication device, and transmits the Link Modification Accept to the first communication device after receiving a response message to the predetermined message from the second communication device.

### Supplementary Note 8

The relay device according to Supplementary Note 1, further including a second determination unit configured to determine the number of relay devices that relay the terminal-to-terminal communication,

wherein the transmission unit transmits the Link Modification Accept to the first communication device based on the message type and the number of relay devices.

### Supplementary Note 9

The relay device according to Supplementary Note 8, wherein in a case where the message type is the first type and the number is equal to or greater than a threshold, the transmission unit transmits the Link Modification Accept to the first communication device before transmitting the predetermined message to the second communication device.

### Supplementary Note 10

The relay device according to Supplementary Note 8, wherein in a case where the message type is the first type and the number is less than a threshold, the transmission unit transmits a predetermined message to the second communication device, and transmits the Link Modification Accept to the first communication device after receiving a response message to the predetermined message from the second communication device.

### Supplementary Note 11

The relay device according to Supplementary Note 2, 6, or 9, wherein the predetermined message is a Disconnect Request or a Link Modification Request.

### Supplementary Note 12

The relay device according to Supplementary Note 3, 7, or 10, wherein the predetermined message is a Link Modification Request.

### Supplementary Note 13

A control method of a relay device that communicates with a first communication device and a second communication device and relays terminal-to-terminal communication, the control method including:

receiving a Link Modification Request from the first communication device; and

transmitting a Link Modification Accept to the first communication device at different timings depending on whether a message type of the Link Modification Request is a first type or a second type.

### Supplementary Note 14

A storage medium storing a program for causing a computer in a relay device that communicates with a first communication device and a second communication device and relays terminal-to-terminal communication to execute a control method of the relay device, the relay device including:

a reception unit configured to receive a Link Modification Request from the first communication device; and

a transmission unit configured to transmit a Link Modification Accept to the first communication device at different timings depending on whether a message type of the Link Modification Request is a first type or a second type,

wherein the control method includes:

receiving a Link Modification Request from the first communication device; and

transmitting a Link Modification Accept to the first communication device at different timings depending on whether a message type of the Link Modification Request is a first type or a second type.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-062172, filed Apr. 4, 2025, which is hereby incorporated by reference herein in its entirety.

What is claimed is:

1. A relay device that communicates with a first communication device and a second communication device and relays terminal-to-terminal communication, the relay device comprising:
at least one memory that stores a set of instructions; and
at least one processor that executes the instructions, the instructions, when executed, causing the relay device to perform operations comprising;
a reception unit configured to receive a Link Modification Request from the first communication device; and
a transmission unit configured to transmit a Link Modification Accept to the first communication device at different timings depending on whether a message type of the Link Modification Request is a first type or a second type.

2. The relay device according to claim 1,
wherein the first type is a Link Modification Request indicating QoS flow deletion, and
wherein, in a case where the message type is the first type, the transmission unit transmits the Link Modification Accept to the first communication device before transmitting a predetermined message to the second communication device.

3. The relay device according to claim 1,
wherein the second type is a Link Modification Request that does not indicate QoS flow deletion, and
wherein, in a case where the message type is the second type, the transmission unit transmits a predetermined message to the second communication device, and transmits the Link Modification Accept to the first communication device after receiving a response message to the predetermined message from the second communication device.

4. The relay device according to claim 1, further comprising a first determination unit configured to determine a usage status of a communication path between the relay device and the second communication device based on the Link Modification Request, and
wherein the transmission unit transmits the Link Modification Accept to the first communication device based on the message type and the usage status.

5. The relay device according to claim 4, wherein the first determination unit determines the usage status based on a first QoS flow included in the communication path.

6. The relay device according to claim 5, wherein, in a case where the message type is the first type and the communication path includes only the first QoS flow, the transmission unit transmits the Link Modification Accept to the first communication device before transmitting a predetermined message to the second communication device.

7. The relay device according to claim 5, wherein, in a case where the message type is the second type and the communication path includes the first QoS flow and a second QoS flow other than the first QoS flow, the transmission unit transmits a predetermined message to the second communication device, and transmits the Link Modification Accept to the first communication device after receiving a response message to the predetermined message from the second communication device.

8. The relay device according to claim 1, further comprising a second determination unit configured to determine the number of relay devices that relay the terminal-to-terminal communication,
wherein the transmission unit transmits the Link Modification Accept to the first communication device based on the message type and the number of relay devices.

9. The relay device according to claim 8, wherein, in a case where the message type is the first type and the number of relay devices is equal to or greater than a threshold, the transmission unit transmits the Link Modification Accept to the first communication device before transmitting the predetermined message to the second communication device.

10. The relay device according to claim 8, wherein, in a case where the message type is the first type and the number of relay devices is less than a threshold, the transmission unit transmits a predetermined message to the second communication device, and transmits the Link Modification Accept to the first communication device after receiving a response message to the predetermined message from the second communication device.

11. The relay device according to claim 2, wherein the predetermined message is a Disconnect Request or a Link Modification Request.

12. The relay device according to claim 3, wherein the predetermined message is a Link Modification Request.

13. A control method of a relay device that communicates with a first communication device and a second communication device and relays terminal-to-terminal communication, the control method comprising:
receiving a Link Modification Request from the first communication device; and
transmitting a Link Modification Accept to the first communication device at different timings depending on whether a message type of the Link Modification Request is a first type or a second type.

14. A non-transitory computer-readable storage medium storing a program for causing a computer in a relay device that communicates with a first communication device and a second communication device and relays terminal-to-terminal communication to execute a control method of the relay device including:
receiving a Link Modification Request from the first communication device; and
transmitting a Link Modification Accept to the first communication device at different timings depending on whether a message type of the Link Modification Request is a first type or a second type.
